(19) United States
(12) Patent Application Publication
(10) Pub. No.: US 2020/0258642 A1
(43) Pub. Date: Aug. 13, 2020

(54) SINTERING WITH SPS/FAST URANIUM FUEL WITH OR WITHOUT BURNABLE ABSORBERS

(71) Applicant: WESTINGHOUSE ELECTRIC COMPANY, LLC, Cranberry Township, PA (US)

(72) Inventors: PENG XU, COLUMBIA, SC (US); LU CAI, COLUMBIA, SC (US); SYLVESTER F. OGUNJI, COLUMBIA, SC (US); EDWARD J. LAHODA, EDGEWOOD, PA (US); LARS HALLSTADIUS, VASTERAS (SE)

(73) Assignee: WESTINGHOUSE ELECTRIC COMPANY, LLC, CRANBERRY TOWNSHIP, PS (US)

(21) Appl. No.: 16/273,591

(22) Filed: Feb. 12, 2019

(51) Int. Cl. G21C 3/60; B22F 3/105; G21C 3/56

(52) U.S. Cl. CPC G21C 3/60; B22F 2003/1052; G21C 3/56; B22F 3/105

(57) ABSTRACT

The present invention relates to nuclear fuel compositions including uranium dioxide with integral fuel burnable absorber, and triuranium disilicide and a composite of uranium mononitride and triuranium disilicide with or without integral fuel burnable absorber, and methods of sintering these compositions. The sintering is conducted using SPS/FAST apparatus and techniques. The sintering time and temperature is reduced using SPS/FAST as compared to conventional sintering methods for nuclear fuel compositions. The nuclear fuel compositions of the present invention are particularly useful in light water reactors.

### FIELD OF THE INVENTION

The present invention relates to light water reactors, uranium fuel compositions for use in light water reactors, and more particularly, to novel methods of sintering uranium fuel compositions using Spark Plasma Sintering (SPS)/Field-Assisted Sintering Technique (FAST).

### BACKGROUND OF THE INVENTION

Light water reactors (“LWRs”) can include pressurized water reactors (“PWRs”) and boiling water reactors (“BWRs”). In a PWR, for example, the reactor core includes a large number of fuel assemblies, each of which is composed of a plurality of elongated fuel elements or rods. The fuel rods each contain fissile material, such as uranium dioxide (“UO₂”), usually in the form of a stack of nuclear fuel pellets; although, annular or particle forms of fuel are also used. The fuel rods are grouped together in an array which is organized to provide a neutron flux in the core sufficient to support a high rate of nuclear fission, and thus, the release of a large amount of energy in the form of heat. A coolant, such as water, is pumped through the core in order to extract some of the heat generated in the core for the production of useful work. Fuel assemblies vary in size and design depending on the desired size of the core and the size of the reactor.

Referring now to the drawings, and particularly to FIGS. 1 and 2, there is shown an embodiment of a light water reactor, by way of example only and one of many suitable reactor types, a PWR being generally designated by the numeral 10. The PWR 10 includes a reactor pressure vessel 12 which houses a nuclear reactor core 14 composed of a plurality of elongated fuel assemblies 16. The relatively few fuel assemblies 16 shown in FIG. 1 is for purposes of simplicity only. In reality, as schematically illustrated in FIG. 2, the reactor core 14 is composed of a great number of fuel assemblies.

Spaced radially inwardly from the reactor pressure vessel 12 is a generally cylindrical core barrel 18, and within the barrel 18 is a former and baffle system, hereinafter called a baffle structure 20, which permits transition from the cylindrical barrel 18 to a squared-off periphery of the reactor core 14 formed by the plurality of fuel assemblies 16 being arrayed therein. The baffle structure 20 surrounds the fuel assemblies 16 of the reactor core 14. Typically, the baffle structure 20 is made of plates 22 joined together by bolts (not shown). The reactor core 14 and the baffle structure 20 are disposed between upper and lower core plates 24, 26, which, in turn, are supported by the core barrel 18.

The upper end of the reactor pressure vessel 12 is hermetically sealed by a removable closure head 28 upon which are mounted a plurality of control rod drive mechanisms 30. Again, for simplicity, only a few of the many control rod drive mechanisms 30 are shown. Each drive mechanism 30 selectively positions a rod cluster control mechanism 32 above and within some of the fuel assemblies 16.

A nuclear fission process carried out in the fuel assemblies 16 of the reactor core 14 produces heat which is removed during operation of the PWR 10 by circulating a coolant fluid, such as light water with soluble boron, through the reactor core 14. More specifically, the coolant fluid is typically pumped into the reactor pressure vessel 12 through a plurality of inlet nozzles 34 (only one of which is shown in FIG. 1). The coolant fluid passes downward through an annular region 36 defined between the reactor pressure vessel 12 and core barrel 18 (and a thermal shield 38 on the core barrel) until it reaches the bottom of the reactor pressure vessel 12, where it turns 180 degrees prior to following up through the lower core plate 26 and then up through the reactor core 14. On flowing upwardly through the fuel assemblies 16 of the reactor core 14, the coolant fluid is heated to reactor operating temperatures by the transfer of heat energy from the fuel assemblies 16 to the fluid. The hot coolant fluid then exits the reactor pressure vessel 12 through a plurality of outlet nozzles 40 (only one being shown in FIG. 1) extending through the core barrel 18. Thus, heat energy, which the fuel assemblies 16 impart to the coolant fluid, is carried off by the fluid from the reactor pressure vessel 12.

Due to the existence of holes (not shown) in the core barrel 18, coolant fluid is also present between the barrel 18 and the baffle structure 20 and at a higher pressure than within the reactor core 14. However, the baffle structure 20, together with the core barrel 18 separate the coolant fluid from the fuel assemblies 16 as the fluid flows downwardly through the annular region 36 between the reactor pressure vessel 12 and core barrel 18.

As briefly mentioned above, the reactor core 14 is composed of a large number of elongated fuel assemblies 16. Turning to FIG. 3, each of the fuel assemblies 16, being of the type used in the PWR 10, basically includes a lower end structure or bottom nozzle 42 which supports the assembly on the lower core plate 26 and a number of longitudinally extending guide tubes or thimbles 44 which project upwardly from the bottom nozzle 42. Each of the fuel assemblies 16 further includes a plurality of transverse support grids 46 axially spaced along the lengths of the guide thimbles 44 and attached thereto. The grids 46 transversely space and support a plurality of fuel rods 48 in an organized array thereof. Also, each of the fuel assemblies 16 has an instrumentation tube 50 located in the center thereof and an upper end structure or top nozzle 52 attached to the upper ends of the guide thimbles 44. With such an arrangement of parts, each of the fuel assemblies 16 forms an integral unit capable of being conveniently handled without damaging the assembly parts.

As seen in FIGS. 3 and 4, each of the fuel rods 48 of the fuel assemblies 16 has an identical construction insofar as each includes an elongated hollow cladding tube 54 with a top end plug 56 and a bottom end plug 58 attached to and sealing opposite ends of the tube 54 defining a sealed chamber 60 therein. A plurality of nuclear fuel pellets 62 is placed in an end-to-end abutting arrangement or stack within the chamber 60 and biased against the bottom end plug 58 by the action of a spring 64 placed in the chamber 60 between the top of the pellet stack and the top end plug 56. The nuclear fuel pellets can be vertically stacked in a fuel rod (as shown in FIG. 4) which is part of a fuel assembly of a pressurized water reactor.

When a new reactor starts, its core is often divided into a plurality, e.g., three or more groups of assemblies which can be distinguished by their position in the core and/or their enrichment level. For example, a first batch or region may be enriched to an isotopic content of 2.0% uranium-235. A second batch or region may be enriched to 2.5% uranium-235, and a third batch or region may be enriched to 3.5% uranium-235. After about ten to twenty-four months of operation, the reactor is typically shut down, and the first fuel batch is removed and replaced by a new batch, usually of a higher level of enrichment (up to a preferred maximum level of enrichment). Subsequent cycles repeat this sequence at intervals in the range of from about eight to twenty-four months. Refueling, as described above, is required because the reactor can operate as a nuclear device only so long as it remains a critical mass. Thus, nuclear reactors are provided with sufficient excess reactivity at the beginning of a fuel cycle to allow operation for a specified time period, usually between about six to eighteen months.

Conventional fuel pellets for use in PWRs, for example, are typically fabricated by compressing suitable powders into a generally cylindrical mold. The compressed material is sintered, which results in a substantial reduction in volume. The resulting sintered pellet is generally cylindrical and often has concave surfaces at each end as a result of pellet design to offset thermal expansion in the pellet centerline. The fuel pellets are typically composed of uranium dioxide (UO₂). The uranium component of the uranium dioxide includes uranium-238 and uranium-235. Typically, the fuel composition of the pellets includes a large amount of uranium-238 and a small amount of uranium-235. For example, a conventional fuel pellet can include a maximum of less than five percent by weight of uranium-235 with the remainder of the uranium in the uranium component composed of uranium-238.

The percentage of uranium-235 in the fuel composition of the pellet can be increased as follows: (i) by using a greater percentage, e.g., greater than five percent by weight (which is currently the licensed limit for many nuclear fuel fabrication facilities), of uranium-235 in the fuel composition or (ii) by increasing the density of the fuel composition to allow for a larger amount of uranium-235. A higher percentage of uranium-235 in the fuel pellet composition can provide economic benefits, such as longer fuel cycles and/or the use of fewer new fuel assemblies during batch replacement of a region. Further, higher thermal conductivity, if it can be obtained, will enable higher thermal duty.

There is an interest in the design and development of accident tolerant fuels. Triuranium disilicide (U₃Si₂) and uranium mononitride/triuranium disilicide (UN/U₃Si₂) composite are potential materials for use in producing such fuels, due to their higher density and thermal conductivity. However, U₃Si₂ and UN/U₃Si₂ composite are difficult to sinter using conventional methods.

As a result of their higher U-235 density, U₃Si₂ and UN/U₃Si₂ composite require increased activity hold-down using more integral fuel burnable absorber (IFBA). Further, some UO₂ fuels also contain IFBA, such as but not limited to, erbium dioxide (Er₂O₃), gadolinium oxide (Gd₂O₃), and zirconium diboride (ZrB₂). The IFBA provides temporary reactivity control, which is primarily effective during the beginning of a reactor cycle and compensates for the excess reactivity present early in cycle due to the loading of fresh fuel. Another important function is reactor powder distribution control. For example, the main advantage of boron-based IFBA (ZrB₂, BN, etc.) is that there is less residual poison penalty. However, boron-based IFBA cannot sinter with UO₂ using conventional sintering technologies because these boron compounds tend to volatilize at conventional sintering temperatures and therefore, a consistent residual level of boron has not been obtainable. Current approaches are to sputter coating or physical vapor deposition of ZrB₂ on the sintered UO₂ pellets. These approaches are expensive and time-consuming. Thus, it is desirable to develop a less expensive and more efficient means of adding the IFBA material.

Furthermore, in order to attain the necessary resistance against reactions with water/steam, the porosity (e.g., open and otherwise) needs to be reduced to levels unattainable by conventional means of sintering.

Thus, there is a need in the art to develop new sintering processes to achieve high-sintered density and optimized microstructure. In accordance with the invention, the new methods include the use of Spark Plasma Sintering (SPS)/Field-Assisted Sintering Technique (FAST) to sinter fuel compositions that include U₃Si₂, UN/U₃Si₂ composite, or UO₂ with IFBA. Furthermore, the new sintering processes provide a cost effective means of adding a greater amount of IFBA, which includes mixing the IFBA with the UO₂, and optionally with the U₃Si₂, and the UN/U₃Si₂ composite, and sintering the fuel/IFBA mixture.

### SUMMARY OF THE INVENTION

In one aspect, the invention provides a method of sintering a fuel composition. The method includes forming a powder sample, which includes a material selected from the group consisting of triuranium disilicide with or without an integral fuel burnable absorber, a composite of uranium mononitride and triuranium disilicide with or without an integral fuel burnable absorber, and uranium dioxide with an integral fuel burnable absorber; employing a SPS/FAST system, which includes a power supply and a vacuum chamber structured to enclose components that include an upper electrode and a lower electrode, an upper punch connected to the upper electrode and a lower punch connected to the lower electrode, and a die assembly constructed of a conductive material, positioned between the upper and lower punches, and structured to hold the powder sample; introducing the powder sample into the die assembly; passing pulsed direct current from the power supply through the die assembly; heating the powder sample; contacting and compressing the powder sample between the upper punch and the lower punch; and sintering the powder sample.

The composite of uranium mononitride and triuranium disilicide can include from greater than zero to about fifty percent by weight of the triuranium disilicide. The powder sample can include a mixture of the triuranium disilicide and the integral fuel burnable absorber. The powder sample can include a mixture of the composite of uranium mononitride and triuranium disilicide, and the integral fuel burnable absorber. The powder sample can include a mixture of the uranium dioxide and the integral fuel burnable absorber. The integral fuel burnable absorber may be selected from the group consisting of UB₂, UB₄, ZrB₂, B, B₄C, SiBn and mixtures thereof.

In certain embodiments of the method, the heating of the powder sample is to a temperature in a range from about 1000° C. to about 1700° C. Further, the sintering of the powder sample may be conducted in a time period from about 0.5 minute to about sixty minutes, or from about five minutes to about ten minutes.

The conductive material of the die assembly may be selected from the group consisting of graphite, boron nitride, tungsten carbide, molybdenum, tantalum and mixtures thereof.

In another aspect, the invention provides a method of forming a water corrosion resistant fuel microstructure. The method includes forming a powder sample, which includes a composite of polycrystalline uranium mononitride grain bonded with triuranium disilicide, and optionally (i.e., with or without), an integral fuel burnable absorber; employing a SPS/FAST system that includes a power supply and a vacuum chamber structured to enclose components which include an upper electrode and a lower electrode, an upper punch connected to the upper electrode and a lower punch connected to the lower electrode, and a die assembly constructed of a conductive material, positioned between the upper and lower punches, and structured to hold the powder sample; introducing the powder sample into the die assembly; passing pulsed direct current from the power supply through the die assembly; heating the powder sample to a temperature at or above the melting point of triuranium disilicide; contacting and compressing the powder sample between the upper punch and the lower punch; and sintering the powder sample.

The powder sample can include the composite of polycrystalline uranium mononitride grain bonded with triuranium disilicide and the integral fuel burnable absorber. The integral fuel burnable absorber may be selected from the group consisting of UB₂, UB₄, ZrB₂, BN and mixtures thereof. In certain embodiments, a U—Si—B glass phase is formed.

### BRIEF DESCRIPTION OF THE DRAWINGS

The invention as set forth in the claims will become more apparent from the following detailed description of certain preferred practices thereof illustrated, by way of example only, and the accompanying drawings wherein;

FIG. 1 is a longitudinal view, partly in section and partly in elevation, of a prior art nuclear reactor to which the present invention may be applied;

FIG. 2 is a simplified enlarged plan view of the reactor taken along line 2-2 of FIG. 1, but with its core having a construction and arrangement of fuel in accordance with the present invention;

FIG. 3 is an elevational view, with parts sectioned and parts broken away for clarity, of one of the nuclear fuel assemblies in the reactor of FIG. 2, the fuel assembly being illustrated in a vertically foreshortened form;

FIG. 4 is an enlarged foreshortened longitudinal axial sectional view of a fuel rod of the fuel assembly of FIG. 3 containing fuel pellets;

FIG. 5 is a schematic of a known SPS/FAST system for use in certain embodiments of the invention; and

FIG. 6 is a schematic showing microstructures of a UN/U₃Si₂ composite as a result of sintering, in accordance with certain embodiments of the invention.

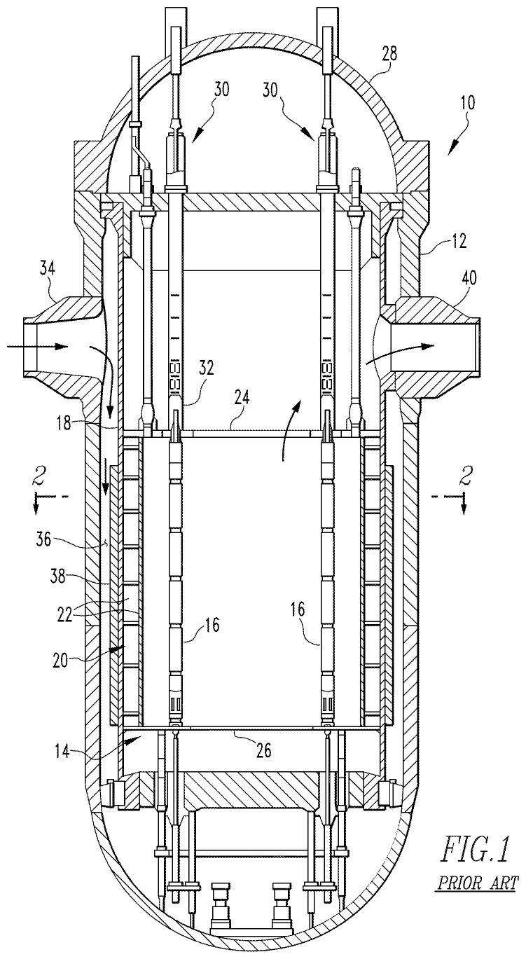

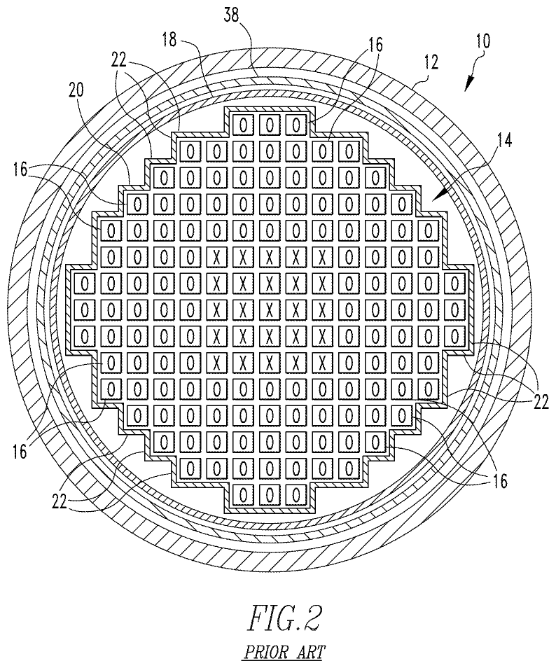

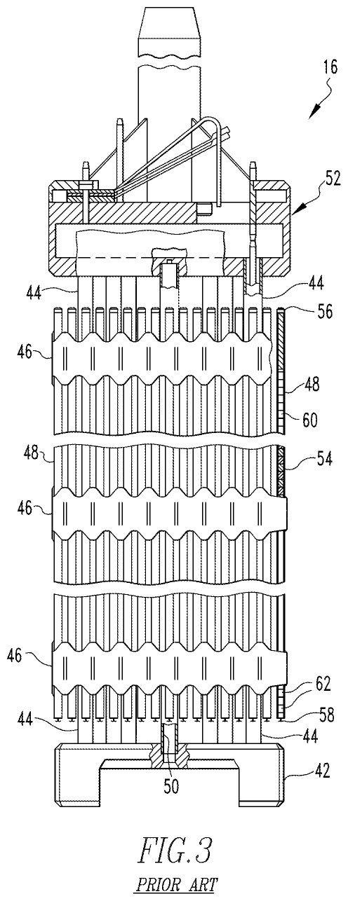

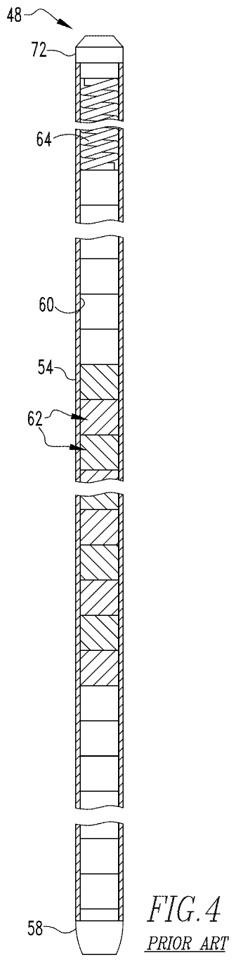

### DETAILED DESCRIPTION OF THE INVENTION

The present invention relates to methods for sintering nuclear fuel compositions including triuranium disilicide (U₃Si₂) with or without integral fuel burnable absorber (IFBA), composites of uranium mononitride (UN) and triuranium disilicide (U₃Si₂) with or without integral fuel burnable absorber (IFBA), and materials of uranium dioxide (UO₂) with integral fuel burnable absorber (IFBA) for use in light water reactors (“LWRs”). In the triuranium disilicide (U₃Si₂) and the composites of uranium mononitride (UN) and triuranium disilicide (U₃Si₂) nuclear fuel compositions, the presence of the IFBA is optional. The composite of UN and U₃Si₂ can include from greater than zero to about fifty percent by weight of the U₃Si₂. The composite can include polycrystalline UN grain bonded with U₃Si₂, with or without the IFBA. The sintering of the nuclear fuel compositions is conducted by employing Spark Plasma Sintering (SPS)/Field-Assisted Sintering Technique (FAST). The present invention is applicable to a variety of LWRs, including but not limited to, pressurized water reactors (“PWRs”) and boiling water reactors (“BWRs”). However, for simplicity in describing the details of the invention, the following description referring to the drawings will be in accordance with a PWR.

In the following description, like reference numerals designate like or corresponding parts throughout the several views. Also in the following description, it is to be understood that such terms as “forward,” “rearward,” “left,” “right,” “upwardly,” “downwardly,” and the like, are words of convenience and are not to be construed as limiting terms.

As previously mentioned, conventional nuclear fuel compositions for use in LWRs include UO₂. The UO₂ contains a significant amount of uranium-238 and a small amount of uranium-235. Further, as previously mentioned, there are economic benefits from increasing the content of uranium-235 in nuclear fuel compositions. Such benefits can include longer fuel cycles or the use of smaller batches. In addition, if a higher thermal conductivity can be obtained, then higher thermal duty can result therefrom. Thus, the use of U₃Si₂ in the fuel compositions of the invention provides an increased amount of uranium-235.

The invention relates to next generation fuels that include U₃Si₂ and UN/U₃Si₂ composite fuels. These fuels have accident resistant uranium compounds, which demonstrate one or more of the following properties: (i) resistance to water corrosion, (ii) higher thermal conductivity than uranium dioxide, (iii) a higher uranium loading than uranium dioxide, and (iv) a melting temperature that allows the fuel to stay solid under Light Water Reactor (LWR) normal operating and transient conditions.

U₃Si₂ and UN have higher thermal conductivity and higher uranium loading than UO₂. Pure UN is not water corrosion resistant at a temperature of 300° C. and above, which prevents the use of UN alone in LWR fuel. However, U₃Si₂ has better water corrosion resistance than UN. Thus, a UN/U₃Si₂ composite can overcome the water corrosion issue related to the use of UN alone.

It is known in the art that the U₃Si₂ and UN/U₃Si₂ composite fuels are difficult to sinter using conventional techniques. For example, it is difficult to consolidate UN and U₃Si₂ using a conventional sintering method. The pellet density of U₃Si₂ is generally below ninety percent (90%) of theoretical density using conventional sintering techniques, unless extensive and expensive milling is applied to the powder beforehand. The UO₂ pellets can reach above ninety-five percent (95%) of theoretical density. As for sintering with IFBA (e.g., different variations of boron, including but not limited to, UB₂, UB₄, ZrB₂, B, B₄C and SiBₙ), the absorbers easily decompose and evaporate at a high sintering temperature. Thus, a new sintering technique with more efficiency, lower sintering temperature and shorter sintering time is desired to produce U₃Si₂ and U₃Si₂/UN fuels with or without IFBA

It is also known in the art that conventional nuclear fuel compositions that include UO₂ may also contain IFBA, which provides temporary reactivity control and compensate for excess reactivity early in the fuel cycle. However, as previously disclosed, IFBA, in particular, boron-based IFBA, cannot sinter with UO₂ using conventional sintering technology. Thus, a new technique capable of sintering at lower temperatures, such as to reduce or preclude the IFBA from volatizing, and maintaining a consistent residual level of IFBA is desired for nuclear fuel including UO₂ with IFBA. For example, in conventional sintering techniques, it has been found that the use of higher temperatures causes the boron of a boron-based IFBA to volatize and as a result, a consistent residual level of boron may not be maintainable.

The invention provides new sintering methods for UO₂ with burnable absorbers, and U₃Si₂ and UN/U₃Si₂ composite fuels with or without burnable absorbers. It has been found that SPS/FAST provides effective apparatus and technique to sinter U₃Si₂ and UN/U₃Si₂ composite fuels, as well as fuels including UO₂ with IFBA. This technique significantly decreases the sintering temperature and sintering time needed, as compared to conventional sintering techniques used for lower U-235 density fuel material. The SPS/FAST provides for heating a powder fuel sample to a temperature in a range from about 1000° C. to about 1700° C., and sintering the powder sample in a time period from about 0.5 minute to about 60 minutes. Moreover, it has been found that SPS/FAST minimizes porosity, which can result in enhanced resistance against corrosion in water/steam. The sintering time for the SPS/FAST process can be minutes, as compared to hours for conventional sintering processes. Generally, SPS/FAST is a low voltage, direct current (DC) pulsed current activated, pressure-assisted sintering, and synthesis technique. SPS/FAST is similar to a conventional hot pressing (HP) technique, but is distinguishable because the mechanism for producing and transmitting heat to the sintering material is different in SPS/FAST as compared to HP. A primary characteristic of the SPS/FAST sintering technique is that DC pulsed current directly passes through a conductive (e.g. graphite) die, as well as a powder compact, for conductive samples. Joule heating has been found to play a dominant role in the densification of powder compacts, which results in achieving near theoretical density at a lower sintering temperature compared to conventional sintering techniques. The heat generation is internal, in contrast to conventional hot pressing, where the heat is provided by external heating elements. Internally generating the heat facilitates a very high heating or cooling rate (up to 1000 K/min), hence the sintering process generally is very fast, e.g., within a few minutes as compared to several hours or more with conventional sintering techniques. The general speed of the process ensures it has the potential of densifying powders with nanosize or nanostructure while avoiding coarsening, which accompanies standard densification methods.

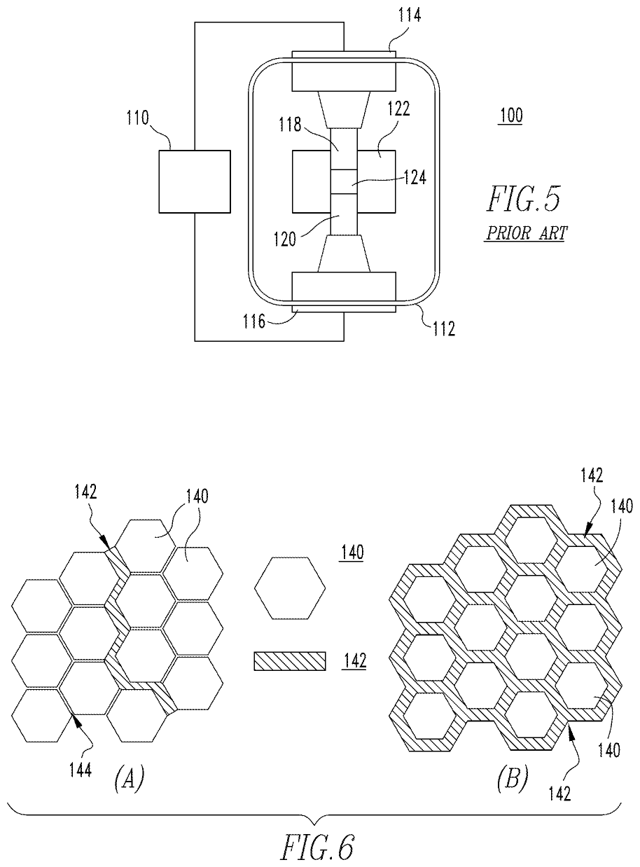

FIG. 5 is a schematic which shows a known FAST/SPS apparatus 100 for use in the invention, which consists of a mechanical loading system that serves as a high-power electrical circuit, placed in a controlled atmosphere. FIG. 5 includes a power mechanism 110 to supply DC pulsed current, and a water-cooled vacuum chamber 112. Positioned within the chamber 112 is an upper electrode 114 and a lower electrode 116, an upper punch 118 and a lower punch 120. Positioned between the upper and lower punches 118, 120 is a die assembly 122. A powder sample 124 is placed in the die assembly 122. Heat is quickly and efficiently transferred to the sample. The process can take place under vacuum or protective gas at atmospheric pressure. The heated parts are located in the water-cooled vacuum chamber 112.

Without intending to be bound by any particular theory, it is believed that the quasi-static compressive stress applied in the SPS/FAST system, e.g., the pressure exerted by the upper and lower punches, provides better contact between particles, changes the amount and morphology of those contacts, enhances existing densification mechanisms present in free sintering (grain boundary diffusion, lattice diffusion, and viscous flow) or activates new mechanisms.

In accordance with the invention, the SPS/FAST process generally includes obtaining the U₃Si₂ or UN/U₃Si₂ with or without burnable absorbers, or UO₂ with burnable absorbers, in a dry, powder form; placing the powder in a die assembly between an upper punch and a lower punch; providing pulsed current flow through the die assembly to cause rapid heating; contacting and compressing the powder between the upper and lower punches; and rapidly and efficiently transferring heat from the die assembly to the powder for sintering. The powder may be heated to the melting temperature of U₃Si₂ (i.e., 1665° C.) or higher.

In conventional sintering techniques, for example, for UO₂, a sintering temperature above about 1750° C. is used in combination with a holding time of approximately five hours. In contrast, for the SPS/FAST process in accordance with the invention, the sintering temperature may be about 1050° C. with a holding time of approximately 0.5 minute. For UN/U₃Si₂, the conventional sintering temperature is greater than about 1800° C. with approximately forty hours of milling prior to sintering. In contrast, for UN/U₃Si₂, SPS/FAST sintering may be accomplished at a temperature of about 1500° C. for a period of approximately ten minutes, without pre-milling to achieve ninety percent (90%) theoretical density. In other embodiments, for UN/U₃Si₂, a temperature of about 1650° C. for approximately three minutes results in above ninety-nine percent (99%) theoretical density.

As a result of rapid sintering (in minutes), the boron-based burnable absorbers (ZrB₂, BN, etc.) have limited time to volatilize and therefore, remain (e.g., are present) in the fuels during the sintering process.

In certain embodiments, the sintering time for the powder sample (fuel composition) is from about 0.5 minute to about 60 minutes. In other embodiments, the sintering time for the powder sample (fuel composition) is from about 5 minutes to about 10 minutes.

Further, as a result of rapid heating of the powder in the SPS/FAST sintering process, high local temperature gradients and non-uniform temperature distribution may exist and cause thermal stress. UN and U₃Si₂ have high temperature conductivity and therefore, the thermal stress is mitigated.

The most commonly used conductive material for a SPS/FAST die (e.g., die assembly 122 in FIG. 5) is graphite. However, because graphite is a moderator, it may not be suitable for mass production in nuclear fuels. Therefore, in accordance with the invention, a material, such as boron nitride, tungsten carbide, or a metal other than graphite, such as, but not limited to molybdenum, tungsten, tantalum, and the like, may be used for the die.

In order to achieve water corrosion resistance, the microstructure of the UN/U₃Si₂ composite may be optimized. FIG. 6 shows UN/U₃Si₂ composite microstructures in accordance with certain embodiments of the invention. View A in FIG. 6 illustrates a UN/U₃Si₂ composite having a desired microstructure, which includes polycrystalline UN grains (140) and grain boundaries (144) there between. A portion of the grain boundaries (144) include a thin layer of U₃Si₂ (142), to bond the polycrystalline UN grains (140) with U₃Si₂ to prevent grain boundary segregation. View B in FIG. 6 shows a UN/U₃Si₂ composite having an ideal or optimum microstructure, wherein all of the grain boundaries include a thin layer of U₃Si₂ (142) in the microstructure, to bond all of the polycrystalline UN grains (140) with U₃Si₂ to prevent grain boundary segregation. The use of the SPS/FAST process provides increased or improved control over the microstructure as compared to conventional sintering processes. For example, it has been found that with UN/U₃Si₂ sintered near the melting temperature of U₃Si₂ (i.e., 1665° C.), the liquid phase or near-liquid phase of U₃Si₂ can be readily distributed along grain boundaries of the UN. Since SPS/FAST can be performed in a short time period (a few minutes), the risk of evaporation of the liquid-phase U₃Si₂ is mitigated. Furthermore, the moderate pressure applied to the powder sample in the die through the upper and lower punches allows for a more homogeneous distribution of U₃Si₂ and UN, which provides for improvement in polycrystalline UN grain bonded with U₃Si₂ at the UN grain boundaries (e.g., as shown in View B of FIG. 6).

In certain embodiments, a U—Si—B glass as a water proofing phase is formed for the composite of polycrystalline UN grain bonded with U₃Si₂ with IFBA, as well as for U₃Si₂ with IFBA.

Whereas particular embodiments of the invention have been described herein for purposes of illustration, it will be evident to those skilled in the art that numerous variations of the details may be made without departing from the invention as set forth in the appended claims.

What is claimed is:

1. A method of sintering a fuel composition, comprising:
forming a powder sample, comprising:
a material selected from the group consisting of triuranium disilicide with or without an integral fuel burnable absorber, a composite of uranium mononitride and triuranium disilicide with or without an integral fuel burnable absorber and
uranium dioxide with an integral fuel burnable absorber;
employing a SPS/FAST system, comprising:
a power supply; and
a vacuum chamber structured to enclose components, comprising:
an upper electrode and a lower electrode;
an upper punch connected to the upper electrode and a lower punch connected to the lower electrode; and
a die assembly constructed of a conductive material, positioned between the upper and lower punches, and structured to hold the powder sample;
introducing the powder sample into the die assembly;
passing pulsed direct current from the power supply through the die assembly;
heating the powder sample;
contacting and compressing the powder sample between the upper punch and the lower punch; and
sintering the powder sample.

2. The method of claim 1, wherein the composite of uranium mononitride and triuranium disilicide comprises from greater than zero to about fifty percent by weight triuranium disilicide.

3. The method of claim 1, wherein the powder sample comprises a mixture of the triuranium disilicide and the integral fuel burnable absorber.

4. The method of claim 1, wherein the powder sample comprises a mixture of the composite of uranium mononitride and triuranium disilicide, and the integral fuel burnable absorber.

5. The method of claim 1, wherein the powder sample comprises a mixture of the uranium dioxide and the integral fuel burnable absorber.

6. The method of claim 1, wherein the integral fuel burnable absorber is selected from the group consisting of UB₂, UB₄, ZrB₂, B, B₄C, SiBn and mixtures thereof.

7. The method of claim 1, wherein the heating of the powder sample is to a temperature in a range from about 1000° C. to about 1700° C.

8. The method of claim 1, wherein the sintering of the powder sample is conducted in a time period of about 0.5 minute to about sixty minutes.

9. The method of claim 7, wherein the sintering of the powder sample is conducted in a time period of about five minutes to about ten minutes.

10. The method of claim 1, wherein the conductive material is selected from the group consisting of graphite, boron nitride, tungsten carbide, molybdenum, tantalum and mixtures thereof.

11. A method of forming a water corrosion resistant fuel microstructure, comprising:
forming a powder sample, comprising:
a composite of polycrystalline uranium mononitride grain bonded with triuranium disilicide with or without an integral fuel burnable absorber;
employing a SPS/FAST system, comprising:
a power supply; and
a vacuum chamber structured to enclose components, comprising:
an upper electrode and a lower electrode;
an upper punch connected to the upper electrode and a lower punch connected to the lower electrode; and
a die assembly constructed of a conductive material, positioned between the upper and lower punches, and structured to hold the powder sample;
introducing the powder sample into the die assembly;
passing pulsed direct current from the power supply through the die assembly;
heating the powder sample to a temperature at or above the melting point of triuranium disilicide;
contacting and compressing the powder sample between the upper punch and the lower punch; and
sintering the powder sample.

12. The method of claim 10, wherein the powder sample comprises the composite of polycrystalline uranium mononitride grain bonded with triuranium disilicide and the integral fuel burnable absorber.

13. The method of claim 11, wherein the integral fuel burnable absorber is selected from the group consisting of UB₂, UB₄, ZrB₂, BN and mixtures thereof.

14. The method of claim 12, wherein a U—Si—B glass phase is formed.
